(19) United States
(12) Patent Application Publication
(10) Pub. No.: US 2008/0071543 A1
(43) Pub. Date: Mar. 20, 2008

(54) Secure Personal Health Information and Event Reminder System and Portable Electronic Device

(76) Inventors: Carl Jarvis, Mt. Laurel, NJ (US); James Gentilin, Lumberton, NJ (US)

Correspondence Address: LICATA & TYRRELL P.C., 66 E. MAIN STREET, MARLTON, NJ, 08053, US

(21) Appl. No.: 11/579,379

(22) PCT Filed: May 12, 2005
(86) PCT No.: PCT/US2005/16472

§ 371 Date: Nov. 26, 2007

Related U.S. Application Data
(60) Provisional application No. 60/570,588, filed on May 12, 2004.

(51) Int. Cl. G10L 21/00

(52) U.S. Cl. 704/270

(57) ABSTRACT

A portable electronic device (100) has an audio speech processor (102) and a microprocessor (101). There is a non-volatile memory (110) and a real time clock (107). The device (100) is encased in a csing (115). The device (100) is connected to a host computer (112) to the microprocessor (101).

This patent application claims the benefit of priority to U.S. Provisional Application Ser. No. 60/570,588, filed May 12, 2004, teachings of which are herein incorporated by reference in their entirety.

### FIELD OF THE INVENTION

The present invention relates to a secure personal information and event reminder system which provides a means for disseminating information for the betterment of the individual regarding at least in part his or her personal health, inclusive of, but not limited to, personal health information, personal identification, analysis based on current information, historical reference, medications and medication compliance.

### BACKGROUND OF THE INVENTION

Reports have shown that almost two-thirds of Americans currently use medicines. However, a major problem in treating illness today is patients' failure to take medications correctly. More than half of all Americans with chronic disease do not follow accurately dosing regimes or lifestyle guidance set forth by their physicians. Failure to take prescription medications correctly leads to 10 percent of all hospital admissions and 23 percent of all nursing home admissions.

A number of devices have been developed to assist with patient medication compliance and/or other health related factors.

Several companies are currently marketing or have plans to market hand-held personal digital assistants designed to provide drug administration scheduling, drug administration verification and electronic documentation of drug administration. Such personal digital assistants (PDAs) can store a user's daily schedule, as well as an address book, notes, lists, etc. Information is typically entered into the PDA by the user on a small visual display controlled by a stylus or keyboard. Speech enabled interfaces for, portable personal devices have also been described in Published U.S. Application No. 2002/0055844.

U.S. Pat. No. 6,811,516 discloses an apparatus comprising a personal digital assistant having a computer program code adapted to assist in at least one of calorie counting, meal selection, meal suggestion, weight monitoring, weight loss or gain monitoring, fat consumption monitoring, sugar consumption monitoring and salt consumption monitoring. The personal digital assistant also includes a computer program code which displays historical data relating to at least one of these parameters.

U.S. Pat. No. 6,158,613 discloses a voice announcement medication storage and dispensing device with a medical storage portion and a closure portion with a data storage means in the closure portion. The device is activated by access to the storage container and can be programmed with medication information including medication dosage, schedule, medical warnings and patient information. This medication storage and dispensing device has a self-contained power source with data processing and memory chip and electronic data interface with audio output. Use of this device, which is described as disposable, is limited to a single prescription or dosing regime.

None of the above-described devices provide a means for collecting and storing medication compliance data or a means for analysis of medication compliance of the patient based on current information and/or historical-reference.

U.S. Published Patent Application No. 2004/0103000 describes a portable medical storage unit device which attaches to a data processing system through a universal serial bus port interface. The portable medical storage stores, reads, decrypts, and classifies data on the data processing system. Data fields into which data is classified include patient data, medical history data, alerts and medications data, notes data and images data. This system, while providing a portable medical record system for a patient provides no event reminder function to assist the patient with medication compliance.

Published U.S. Application No. 2001/0044731 discloses an informational management system and method capable of monitoring, controlling and validating the administration of medical care delivery in a health care facility. Their system includes a medical transaction carrier containing information concerning past and present medical transactions used to transfer this information between a control system interfaced with various other care-giving institutional informational systems such as a pharmacy information system, a hospital information system, a physician's order entry system or a patient specific asset located at a patient's bedside. This system, while providing for better medication compliance during a patient's stay in a health care facility, provides no assistance with medication compliance once the patient has left the health facility.

Accordingly, there is a need for secure personal health information and event reminder systems which not only remind a patient to take medications but also provide a means for caretakers to ensure that a patient is medication compliant.

### SUMMARY OF THE INVENTION

An object of the present invention is to provide a secure personal health information and event reminder system, in particular to, personal, historical, medical, and medication information, which is programmable by means of data entry from a host computer which is then transferred to a portable electronic device where the primary output method of the system is an audible speech output associated with time based events and records. Information from the system and device of the present invention may be used for example for disease management, including preventative care or specific care related programs associated with both chronic and acute conditions including, but in no way limited to, diabetes management, asthma management, weight management, or people with visual or memory impairments such as Alzheimer's disease.

The system of the present invention provides a means for: defining events and records in a secure environment, where each event and record may be defined as secure, or non-secure related to it's data content; defining events and records based on text, which is not limited by type; defining each event and record output by means of visual, tactile, or audible speech, not limited by type; event reminders by means of a visual, tactile, or an audible speech output; generating future time and date events; notification of the next event expiration time and date by means of a visual or an audible speech output; recording expired events with the time and date, as a record of the event; notification of the last event record by means of a visual or an audible speech output; storing personal information; notification of personal information; transferring selected information, events and records to a host computer for further analysis including, but in no way limited to compliance and correlations; recording information generated from other devices; temporarily disabling the audible speech output; indicating the time, day and date by means of a visual or an audible speech output; a timer, ascending or descending; a counter with a visual or audible speech output; audible speech output of selected text; individual secure identification; owner encryption of events and records; battery recharging; wired and wireless communications; and/or external speaker output.

### BRIEF DESCRIPTION OF THE FIGURES

FIG. 1 provides a block diagram showing an exemplary arrangement of components of one embodiment of a portable electronic device used in the secure personal health information and event reminder system of the present invention.

FIG. 2 provides a block diagram of an embodiment of the secure personal health information and event reminder system wherein the portable electronic device is linked to a host computer. As shown by the arrows, data can be transferred both from the host computer to the portable electronic device and from the portable electronic device to the host computer.

FIGS. 3a-3c show an exemplary portable electronic device of the present invention.

FIG. 3a is a front view of an embodiment of the portable electronic device showing first and second user function buttons, a visual output and the protective casing. In the embodiment depicted in FIG. 3a, a portion of the protective casing is removable.

FIG. 3b is a cross-sectional side view showing an exemplary arrangement for inner components of the portable electronic device.

FIG. 3c is a back view of an embodiment of the portable electronic device showing the audible output and protective casing. Like FIG. 3a, in the depicted embodiment a portion of the protective casing is removable.

FIG. 4 shows another embodiment of the portable electronic device wearable as a wrist band. In this embodiment, both the user function buttons and the audible output appear on the front of the device. In this embodiment, no portion of the protective casing is removable.

FIG. 5 is a flow diagram showing data content on the portable electronic device for an expired time-based event.

FIG. 6 is a flow diagram showing data content on the portable electronic device for non-secured information.

FIG. 7 is a flow diagram showing data content on the portable electronic device for a non-expired event.

### DETAILED DESCRIPTION OF THE INVENTION

The present invention provides a portable electronic device and system for monitoring and recording personal health information in a matter which is secure and is accessible by the user and/or authorized personnel.

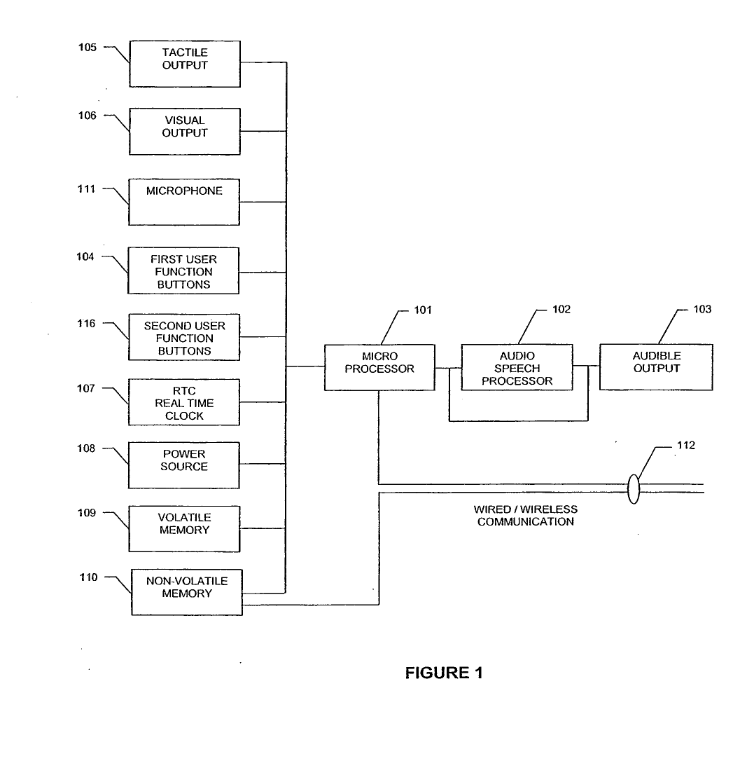

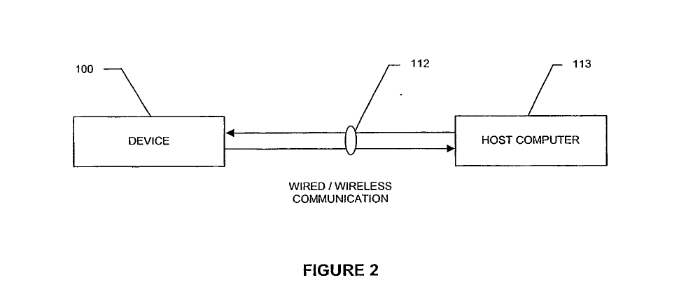

The term “system” as used herein is meant to be inclusive of a portable electronic device 100, examples of which are depicted in FIGS. 1, 3 and 4, linked to a host computer 113. An exemplary system is depicted in FIG. 2. As shown in FIG. 2, information is entered onto the portable electronic device 100 via the host computer 113. The portable electronic device 100 is also capable of transferring information back to the host computer 113.

The portable electronic devices of the present invention can be used to store various types of information. In a preferred embodiment these portable electronic devices are configured to collect and store personal health information relating to, for example, medications and other health related issues of an individual. Portable electronic devices of the present invention are configured for all medications, including prescription, non-prescription, and over-the-counter (OTC) medications, as well as other events and/or remedies that one may take for the betterment of one's health including but in no way limited to, vitamins, herbal remedies and other holistic cures. The portable electronic devices of the present invention can also be conveniently configured to provide reminders of more general, non health related events.

Information is entered into the portable electronic device as an event or record, based, at least in part, on time and dates.

For purposes of the present invention, by “event” it is meant any specified type of information, which may or may not require a future action, or may or may not be set to expire at a future time and date. Thus, events may or may not include a time/date association. For example, an event may be a reminder for an appointment with a time/date association. However, if the event is structured around information such as a person's name, then this event would not have a time/date association. The events are entered in text form, which does not limit the event by type. Further descriptions of types of events may include; doctor's and dentist's appointments, anniversaries, birthdays, prescription medications including those which are as needed and those which are as required, non-prescription over-the-counter medications, daily reminders, lists, etc. Since events are not limited by type they may also include features or content such as calendars, address book, voice recordings, counters, timers, and other information typically found in organizers or a PIM (Personal Information Manager). Information may also represent types stored on other media. For example, information may include indicators of an advanced medical directive or organ donor information, which is typically stored in paper form. The electronic portable device may have an electronic version of this information stored in non-volatile memory, as well as a visual or speech output version of the same information.

By “record”, for purposes of the present invention it is meant an archive of an event with a specific time and date.

Additional examples of events and records which may contain personal identifiable information include, but are in no way limited to, information such as owner's name, address, phone number, insurance information including policy number, social security number, emergency contact information, age, weight, height, eye color, blood type, known allergies, medical conditions, medical history, current medications, appointments, contacts, calendar events and/or reminders.

When an active event expires, the user is alerted by a visual or an audible speech output of the system. If the event is set to record, the device initiates a request from the user to record the event. The user can record and/or delete expired events. The user can also view, or listen to events and records stored on the device. In addition, the user can configure and access events and records stored on the device by means of a single event, or record, or group, or sub category.

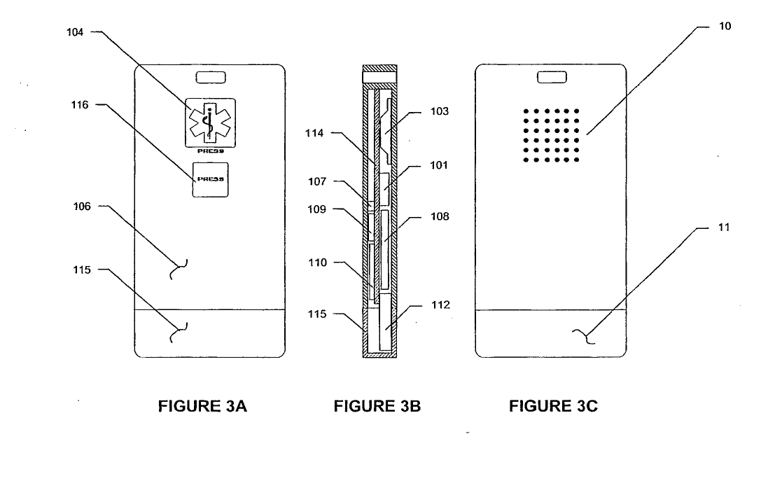

In simplest form, the portable electronic device 100 comprises a printed circuit 114, a power source 108, a audio speech processor 102, and a microprocessor 101 with volatile 109 and non-volatile 110 memory capabilities and a real time clock 107, each encased within a protective casing 115 as well as a first user function button 104 and a means for connecting to a host computer 112 connected to the microprocessor 101 and an audible output 103 connected to the audio speech processor 102 positioned on the outside of the protective casing 115. See FIG. 3a through 3c.

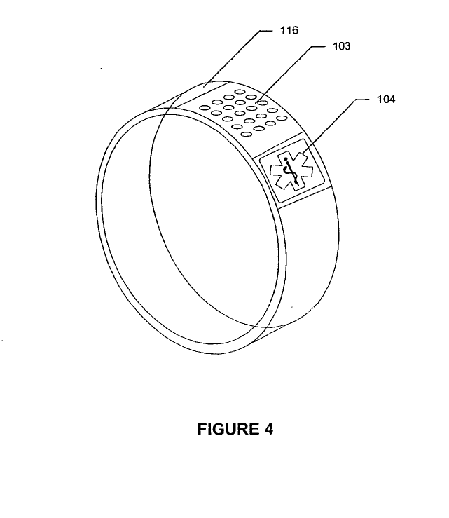

In some embodiments, as shown in FIGS. 3a and 3c, a portion of the protective casing 115 is removable and the means for connecting to the host computer 112 is actually located underneath this removable portion of the protective casing. In this embodiment, this portion of the protective casing must be removed prior to connecting the portable electronic device to a host computer via such means 112. In other embodiment, such as depicted in FIG. 4, no portion of the protective casing is removable.

The primary output means for the portable electronic device 100 of the present invention comprises an audible speech processor 102 located within the protective casing 115 of the portable electronic device 100 connected to an audible output 103 which extends from the inside to the outside of the protective casing of the portable electronic device so that projected sound can be heard by the user.

The audio speech processor 102 provides for conversion of an event, or record, for playback through the audible output 103. The audible speech processor 102 may provide for text to speech conversion on the portable electronic device itself. Alternatively, or in addition, it may provide audio decoding of an audio file created by text to speech on a host computer, not specified by format. Alternatively, or in addition, the audible speech processor may also provide audio decoding of audio files generated by the portable electronic device or host computer.

The audible output 103 comprises most simply a speaker as the primary means of output. Speech output language is in no way confined to English, but rather can be in any language understood by the users. Further, the electronic portable device, and or host computer, may provide means for language conversion in other languages like Spanish, English (UK), French, German, Mandarin, and others. The electronic portable device may further comprise additional audible output components including, but not limited to alarms, beepers, buzzers, audio transducers, and/or external connectors for use with external speakers, earphones, ear buds, or such.

Preferably the portable electronic device will have a means for temporarily turning off the audible output thereby providing the user with full control over the functionality of the audible output. As such, the user may temporarily turn off the audible output while in, for example, a movie theater, or during his or her typical sleep hours. Preferably when the audible output is temporarily turned off, the device is equipped with visual output components 106 which remain active or stay on.

The portable electronic device further comprises a printed circuit 114. This printed circuit may be rigid or flexible.

The portable electronic device 100 further comprises a microprocessor connected to the audio speech processor as well as additional components of the device. See FIG. 1. The microprocessor executes the program codes for processing audio conversion and decoding relating to reminders of events and for recording actions in response to such reminders as archived records.

The portable electronic device 100 further comprises volatile memory 109 and non-volatile memory 110. Volatile memory is used for program operation for temporary data storage. For example, when comparing two date values, a date temporary difference value will be the result. This temporary result will be stored in volatile memory and used for subsequent calculations during program execution. Volatile memory by definition means that any values stored will be lost if there is a system power loss (i.e. depleted battery). Since all values in volatile memory are temporary, they will be re-initialized to correct values by the program once power is restored. Non-volatile memory is used for persistent storage of user data events and records. For example, all events will be stored in non-volatile memory so that, in the event of power loss, these events will remain in the device for use when power is resumed.

Volatile memory and non-volatile memory may consist of either a fixed media or removable media, which is not limited to capacity, physical size, physical embodiment, or format. Examples of removable media based on current technologies may include the use of a compact flash card, secure digital card, mini-secure digital card, or similar format and capabilities. As will be understood by those skilled in the art, however, as new memory technologies are developed they may be used in similar fashion in the present invention to current known technologies.

The electronic portable device 100 further comprises a real time clock 107 linked to the microprocessor 101. The real time clock allows the microprocessors to process, read, and write content based on time. The electronic portable device 100 will use industry standards persistent in describing the content and format of time data structures which take into account a world clock based on time zones. In some embodiments, the electronic portable device 100 may include a time and date display functionality generated by the real time clock 107 as a visual output component 106.

The electronic portable device 100 further comprises a power source 108. Examples of power sources 108 useful in the portable electronic device of the present invention include, but are in no way limited to, a direct current battery or batteries, as well other types of rechargeable and non-rechargeable light weight, small batteries, and other light weight, small power sources including current technologies and trends around alternative power sources such as photovaltaics, fuel cells, and the like. In a preferred embodiment the power source is rechargeable and the electronic portable device further comprises the means for connection to a power recharger, or an external back-up power source.

Events and records are entered into the device and/or accessed by the user via user function buttons located on the outside of the protective casing and which are functionally integrated and/or connected to the microprocessor. Functionality of the user function buttons may or may not be limited in use. For example, the function button may be limited in use when it pertains to access of specific information like the first function button 104 described in FIG. 3 representing access to personal related information. By “personal related information” as used herein in relation to the first user function button, it is meant information about or related to the owner and may or may not contain personal identifiable information. Examples of such personal related information include, but are in no way limited to information typically part of a Personal Health Record, such as, name of owner, address of owner, closest living relative of owner and/or contact information for next of kin, emergency contact information, advanced directives, organ donor information, known allergies, important health conditions or disease states of owner, recent health related procedures or information pertaining to or about procedures or directives which were experienced by the owner. Pressing of the first user function button 104 will initiate the microprocessor to signal for an audio output inclusive of one or more of these pieces of personal related information.

The portable electronic device further comprises a means for communication 112 or an interface from the device to a host computer. This means for communication may comprise any wired or wireless communication means used routinely by those skilled in the art. Further, the device is not limited to a single use and may include multiple interfaces. The communication interface may include communication of events and records stored on the device, as well as communication of events both expired and non-expired. The communication interface is not defined or limited by type, and as an example may include a proprietary interface or interface standards like a universal serial bus, BlueTooth, Firewire, radiofrequency identification, infrared data association, 802.11, Zigbee, etc. Wired and wireless communications may be uni-directional, or bi-directional communications.

The device further comprises a protective casing 115 which surrounds and protects components of the device such as the microprocessor, non-removable non-volatile memory, the power source, and the audio speech processor. The protective casing may be comprised of any moldable or formable material or combined composite material. Examples of such materials include, but are in no way limited to ABS plastic, titanium, or a rubber composite material.

As shown in FIGS. 1 and 3, the portable electronic device may further comprise a second user function button or buttons 116, tactile output 105, a visual output 106, and/or an audible input means 111.

Unlike the first user function button 104 with limited use, additional secondary user function button or buttons 116 such as depicted in FIG. 3 have unlimited use and may pertain to a myriad of process issues as defined in code and executed by the microprocessor. Examples of second user function buttons include, but are in no way limited to, user response actions to events and/or reminders, text entry means, and system settings such as volume control for audio output and brightness control for visual output.

The audible input means 111 preferably comprises a microphone or another means capable of generating an audio file.

The visual output 106 may be comprised of one or more of the following; light emitting diode (LED), organic light emitting diode (OLED), electro luminescent (EL), liquid crystal display (LCD), printed graphical images, or any other media used as an identifiable characteristic. Further as will be understood by those skilled in the art upon reading this disclosure, as new visual output technologies are developed that may be used in similar fashion in the present invention to current visual output technologies. One example of visual component may be a low battery level indicator. Visual components may also be combined with other components of the device. As an example, one of the function buttons which refers to medical information may include a visual symbol of the staff of Aesculapius, which is a universal medical symbol symbolic to the medical community. EL may also be used as a means of establishing visual stimuli to an expired event or as a means of providing backlight capabilities. In addition, visual components such as OLED, LCD, and other current technologies may be used for displaying text, data content, graphical images, or a means of text entry.

By a tactile component 105 it is meant any component designed to provide a signal to the user via tactile sensory output. Examples of tactile sensory components useful in the present invention include, but are in no way limited to an internal vibration motor to aid in identifying when an event has expired and an internal vibration sensor, as a means of identifying and recording information relative to movement of the device. Tactile components may also be combined with other components in the system. For example, the function buttons may have brail embossed to help identify the feature.

As will be understood by those of skill in the art upon reading this disclosure, the components identified in the block diagram are not confined by definition and may be altered, substituted, or combined, in accordance with well-established industry practice. An example of this is to combine multiple components into a single die, or combining multiple components into a single component solution such as combining a microprocessor with built in volatile and non-volatile memory, a real time clock and/or text to speech capabilities.

Further, as depicted by FIGS. 3 and 4, the portable electronic device may have various shapes and/or sizes. In one embodiment, as shown in FIG. 3, the portable electronic device resembles the shape and/or size of a cell phone or personal digital assistant. Alternatively, as depicted in FIG. 4, the portable electronic device may be fastened to a wrist or arm band and worn by the user. As will be understood by those of skill in the art upon reading this disclosure, however, FIGS. 3 and 4 merely provide exemplary embodiments of the various configurations which the device of the present invention may take and in no way is the portable electronic device of the present invention limited to these exemplified configurations.

Systems of the present invention further comprise a host computer 113 which can be linked to the portable electronic device 100.

By host computer it is meant to include any computer system capable of communicating with the portable electronic device. Examples include, but are in no way limited to desktops, laptops, tablets, servers, personal digital assistants, embedded computer systems, pagers, cell phones, landlines, and Kiosks. The host computer may store none, all, or a subset of the data downloaded to and/or from the portable electronic device. The host computer may, or may not run the event and reminder application on the device; however to store data on the device, it is required that the host computer have an application capable of providing data input. As a nonlimiting example, data input and format may be supplied by or to a host computer currently providing data content and structure using industry standards specific to the medical community such as Health Level 7 (HL7), Clinical Document Architecture (CDA), Continuity Care Record (CCR), National Council for Prescription Drugs Program (NCPDP), SNOMED CT, RxNorm, Electronic Medical Record (EMR), Electronic Health Record (EHR), or Personal Health Record (PHR) applications. Data stored on the portable electronic device can be accessed via the host computer provided that the host computer has sufficient security privileges as set forth by the user, or owner of the portable electronic device.

The host computer provides the system of the present invention with the means for creating, monitoring, and recording events and personal information. The host computer also provides the system with capability of administering and monitoring multiple portable electronic devices for a single user, as well as multiple portable electronic devices of different users. The users of the host computer may use the host computer only or may also be a user of the electronic portable device as well. Events and records, which are downloaded to the device, remain in the devices domain until they are transferred back to the host computer. The ability to copy and move events and records enables the device to communicate between a multitude of host computers and/or interfaces.

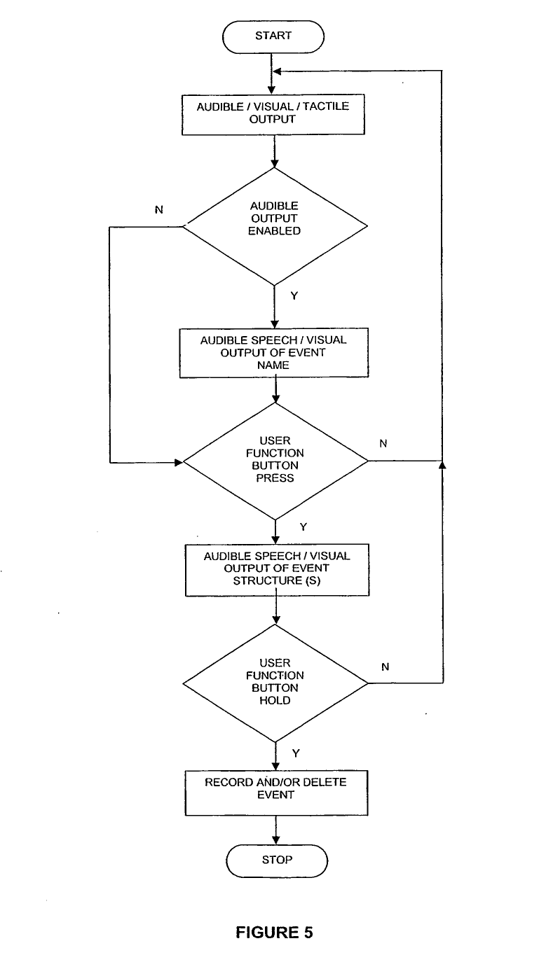

FIGS. 5 through 7 are block diagrams showing the flow of data through the electronic portable device.

FIG. 5 represents data flow of events that expire, which are time based, and where the device is waiting for an action to be taken by the individual. When the individual presses the function button when an event has expired, the event structure is either displayed visually, or played through the audible output. When he or she is done viewing or listening to the event, he or she can either record and/or delete the event.

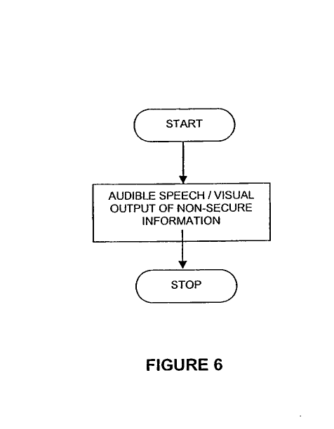

FIG. 6 represents data flow of non-secure information stored on the device, which the individual can listen to or see displayed on the device when he or she presses the function button associated with information, i.e. the medical information button. Typically, this type of information content can not be deleted or recorded at the device level, but may be at the host computer level.

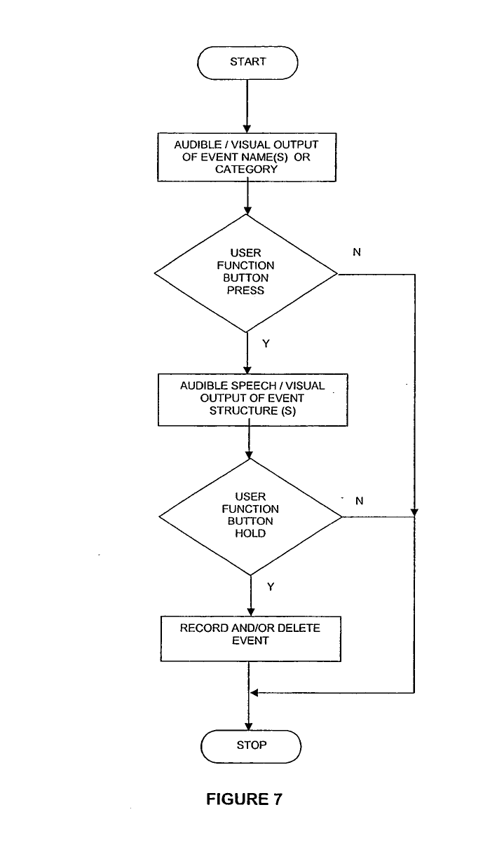

FIG. 7 represents data flow of events or records that have not expired, which may or may not be time based events, which the individual would like to access regarding status, content, or information pertaining to the event or record. Again, the event content may either be displayed visually, or played through the audible output. This data content flow diagram describes access to events which may or may not be time based, or may have a future time based expiration associated with the event.

The portable electronic device of the present invention is associated with only one person. However, one person may have more than one portable electronic device. Active events and records are automatically controlled through the portable electronic device when the device is in use.

The device is automatically in use when it is not connected to a host computer.

Each device preferably is labeled on the outside of the protective casing with a unique serial number. When the device is activated for the first time, a unique secure identification number (SID) specific to the individual owner is created and stored on the device, host computer, and or server. Security of data content and access will be provided using industry standards based on current technologies. The user of the device may employ a password only level of security, or may employ a cryptographic system. In a cryptographic system, the information stored on the device is encrypted. The device and Host Computer may use a private/public key for decrypting information, such as digital signatures and certificates. When accessing secure encrypted information stored on the device, the device may also use strong private key standards which require password authentication prior to decryption.

The owner of the device, or authorized personnel with unlimited access, such as a physician, a pharmacist, or a caregiver, may generate events and records transferred to the portable electronic device. The current events and records stored on the device are secure and may only be accessed by authorized personnel, such as, the owner, a physician, pharmacist, caregiver, or emergency personnel.

Security of data content and access will be provided using industry standards based on current technologies. The user of the device may employ a password only level of security, or may employ a cryptographic system. In a cryptographic system, the information stored on the device is encrypted. The device and host computer may use a private/public key for decrypting information, such as digital signatures and certificates. When accessing secure encrypted information stored on the portable electronic device, the portable electronic device may also use strong private key standards which require password authentication prior to decryption.

There are three types of users defined for systems of the present invention. They are the owner or user of the device, authorized personnel, and non-authorized personnel. There are a limitless number of authorized personnel; however, the sub class of authorized personnel will include those with unlimited access, as well as those with limited access, as defined by the owner. Non-authorized personnel encompass all people, which are not defined as either the owner, or authorized personnel.

By owner, it is meant the owner and typically the user of the device and potentially the user of the host computer. The owner refers to the person whose name is associated with the user profile. Every event and every record is associated with only one person. The owner may also maintain, and monitor, his own database. If information pertaining to an event or record is defined, the user may access the information during the access of the event, or record. In example, if associated information about a prescription medication was stored on the device, like symptoms of the medication, a user while listening to a prescription medication event reminder, may access the associated information while listening to the prescribed medication reminder.

By authorized personnel with unlimited access it is meant a person who is administering and monitoring the user's events and records and potentially maintaining the patient's database. Examples of authorized personnel with unlimited access include, but may not be limited to doctors, pharmacists, and caregivers. In some embodiments, the authorized personnel with unlimited access such as a doctor may maintain the patient's database, particularly in situations where patients are unable to do so for themselves. This may be the case for some elderly patients who do not have access to a computer, or feel intimidated by one. In embodiments where the owner is entering the information and maintaining his or her own database records, the doctor's role is more analytical. The doctor may be the owner's family doctor (primary care physician or general practitioner), obstetrician or gynecologist, a specialist, a dentist, a psychiatrist, a veterinarian, or any other person, which the owner typically makes an appointment to see, and one who would track and monitor the owner's condition or prescribe some sort of treatment.

A pharmacist, or pharmacy, is the person who fills a prescription. They may also provide services for administering and monitoring the user's events and records, such as, information pertaining to over-the-counter medications. The pharmacist will typically have unlimited access to the active records currently stored on the device.

The caregiver is a person whom is trusted by the owner and may temporarily control the device or aid in maintaining the database records. The caregiver may also be limited to what they have access to, whether it is the database, or the device itself. Typical caregivers may be day-care providers for children, a home nurse, a school nurse, a relative, a baby sitter, a friend, or a family member.

Examples of authorized personnel with limited access include, but are not limited to, emergency personnel and individuals whom the user trusts to access information in the event of an emergency. Access to information may aid in personal identification, allergies, age, specific medical conditions, address, contact information, insurance information, etc. Typical emergency personnel may include emergency medical technicians, police, and hospital emergency personnel as well as administrative personnel.

By non-authorized personnel it meant individuals whom the owner may, or may not trust, or may consider a stranger. The owner may not wish them to use or have access to any information pertaining to their device or their records, specifically if the device or records are user specific. Any non-authorized personnel will not have the means of accessing the data, due to encryption. Any person that obtains a lost or stolen device is defined as non-authorized personnel.

1. A portable electronic device comprising:
(a) an audio speech processor;
(b) a microprocessor with volatile and non-volatile memory capabilities and a real time clock linked to the audio speech processor;
(c) a printed circuit on which the microprocessor resides;
(d) a protective casing surrounding the audio speech processor and microprocessor;
(e) an audio output connected to the audio speech processor and extending through the protective casing to project sound from the portable electronic device;
(f) a first user function button connected to the microprocessor positioned outside of the protective casing which when pressed initiates an audio output containing personal related information;
(g) a means for connecting the microprocessor to a host computer through which an event relating to personal, historical, medical, and medication information is transferred to the portable electronic device to remind a user of the event and a record of action is transferred from the portable electronic device to a host computer; and (g) a power source.

2. The portable electronic device of claim 1 further comprising a tactile sensory component which reminds the user of an event, identifies a function of the user function button, or signals low power.

3. The portable electronic device of claim 1 further comprising a visual sensory component which reminds the user of an event, identifies a function of the user function button or signals low power.

4. The portable electronic device of claim 1 further comprising an audible input device.

5. The portable electronic device of claim 1 further comprising a unique identifier to the device.

6. The portable electronic device of claim 1 further comprising a secondary user function button or buttons.

7. The portable electronic device of claim 1 further comprising a wrist band or arm band to which the portable electronic device is attached.

8. A secure personal health information and event reminder system comprising the portable electronic device of claim 1 linked to a host computer capable of data input to the portable electronic device.
